(19) United States
(12) Patent Application Publication
(10) Pub. No.: US 2016/0068628 A1
(43) Pub. Date: Mar. 10, 2016

(54) METHOD FOR PRODUCING POLY-L-LACTIC ACID BY DIRECTLY POLYCONDENSATING L-LACTIC ACID

(71) Applicant: TECHNISCHE UNIVERSITÄT BERLIN, Berlin (DE)

(72) Inventors: Reinhard SCHOMAECKER, Berlin (DE); Karl-Heinz REICHERT, Berlin (DE); Jennifer RAASE, Berlin (DE)

(73) Assignee: TECHNISCHE UNIVERSITAET BERLIN, Berlin (DE)

(21) Appl. No.: 14/786,467

(22) PCT Filed: Apr. 23, 2014
(86) PCT No.: PCT/EP2014/058249

§ 371 Date: Oct. 22, 2015

(30) Foreign Application Priority Data
Apr. 24, 2013 (EP) 13165159.8

(51) Int. Cl. C08G 63/06; C08G 63/80; C08G 63/85

(52) U.S. Cl. CPC C08G 63/06; C08G 63/85; C08G 63/80

(57) ABSTRACT

A method for producing high-molecular poly-L lactic acid by directly polycondensating L-lactic acid using a melt-phase condensation and a subsequent solid-phase condensation using acidic and supported solid catalysts. A method of using an acidic and supported solid catalyst for producing high-molecular poly-L lactic acid by directly polycondensating L-lactic acid, preferably supported and calcined zirconium sulfate is also disclosed.

The invention relates to a process for preparing high molecular weight poly-L-lactic acid by direct polycondensation of L-lactic acid by means of melt phase condensation and subsequent solid phase condensation using acidic and supported solid-state catalysts. The invention also relates to the use of an acidic and supported solid-state catalyst for preparing high molecular weight poly-L-lactic acid by direct polycondensation of L-lactic acid, preferably supported and calcined zirconium sulfate.

Polylactic acid, i.e. condensation polymers based on lactic acid, is for many reasons a particularly attractive group of biopolymers. They are semicrystalline polymers (crystallinity up to 40%). The glass transition temperature is dependent on the water content and is from about 50 to 70° C. The melting point is generally from 170 to 180° C. Their main degradation product, viz. lactic acid, is a naturally occurring product, is nontoxic and is widely used in the food and pharmaceutical industry. Two synthetic routes can in principle be used for preparing polylactic acid. Firstly, polycondensation in which a polymer is produced directly from lactic acid. The direct polycondensation is generally carried out in organic solvents. However, only relatively low molecular weight products (Mn<10⁴ g/mol) are obtained as a result of the ring-chain equilibrium. Industrially relevant polyesters, however, require molar masses in the region of Mn=10⁵-10⁶ g/mol.

Polylactic acid is for this reason prepared, as is known, mainly by ring-opening polymerization of lactide, viz. the cyclic condensate of two lactic acid molecules. The ring-opening polymerization takes place at temperatures in the range from 140 to 180° C. in the presence of catalytically active tin compounds (e.g. tin octoate). Polymers having a high molar mass and strength are produced in this way. Lactide itself can be obtained from lactic acid by (pre)polycondensation and subsequent depolymerization.

Polylactic acid is a biodegradable and biocompatible polymer and is used, inter alia, as packaging material, encapsulation material for pharmaceuticals and as resorbable surgical stitching material.

However, for such applications and also for reasons of environmental protection, the use of the sometimes toxic heavy-metallic tin compounds is undesirable since these are also present as impurities in the product, as a result of which additional purification steps become necessary.

Apart from tin catalysts, other possible catalysts are also known. Thus, for example, EP 2 280 036 A1 describes the direct preparation of polylactic acid using compounds containing sulfonic acid groups as acid catalysts, with the reaction being carried out as melt phase condensation and subsequent solid phase condensation. A disadvantage is that the compounds containing sulfonic acid groups remain in the end products.

It was therefore an object of the invention to discover catalysts for the direct polycondensation of L-lactic acid which can easily be removed from the product. The catalyst should be highly active and selective and it should be possible to prepare a catalyst-free and enantiomerically pure poly-L-lactic acid which is at least 48%, preferably about 80%, crystalline in order to satisfy the requirements of applications in which a high mechanical strength and hardness of the poly-L-lactic acid is necessary.

The object is achieved by a process as claimed in claim 1.

The process of the invention for preparing poly-L-lactic acid by direct polycondensation of L-lactic acid is characterized in that L-lactic acid is subjected in the presence of an acidic and supported solid-state catalyst to the melt phase condensation and the catalyst is removed from the melt before the subsequent solid-state condensation or from the end product after the solid-state condensation.

The use of the solid-state catalyst according to the invention during the melt phase condensation surprisingly leads to a semicrystalline polylactic acid having a crystallinity of from 10 to 50%, preferably from 10 to 40%, particularly preferably from 35 to 50%, and a molar mass M_{w} (number average) in the range from 5000 to 20 000 g/mol, preferably about 20 000 g/mol. The poly-L-lactic acid obtained comprises more than 98 mol % of L-lactic acid units. The maximum melting point is about 160° C. The crystallinity was able to be increased to 60% by purification.

High molecular weight poly-L-lactic acid having a crystallinity of more than 70% is prepared by an optional subsequent crystallization process and a solid-state condensation.

L-Lactic acid which is commercially available is used as starting material. The lactic acid is usually provided as an aqueous solution containing 80-95% by weight of L-lactic acid, 10-15% by weight of water, small amounts of D-lactic acid (about 0.4% by weight) and other impurities.

The melt phase condensation is therefore carried out by dewatering the lactic acid in a first step and heating it to above the melting point in the second step. To effect dewatering, the L-lactic acid is heated to a temperature of preferably from 70 to 150° C. This can be carried out in series with setting of different pressures. The dewatering in the process of the invention is preferably carried out at 75-85° C. The temperature is particularly preferably 80° C. for about 30 minutes at a preferred pressure of 50 mbar.

The actual melt phase condensation is carried out at a temperature in the range from 150 to 200° C. with removal of the water liberated. It is preferably likewise carried out under reduced pressure. The reaction time is preferably 5-60 hours. In general, a preferred temperature of about 180° C. is selected. The pressure set is from 0.5 to 50 mbar, preferably 15 mbar. Since the reaction product contains water, the catalyst has to be water-tolerant. In this way, depending on the catalyst and the catalyst concentration (for example 0.3% by weight), a poly-L-lactic acid having a molar mass (number average) of up to 20 000 g/mol can be obtained in a time of preferably from 10 to 30 hours.

According to the present invention, an acidic solid-state catalyst which is coupled to a support is used as catalyst. In one variant of the invention, the catalyst is removed from the product melt after the melt phase condensation after a polylactic acid product having a preferred molar mass (number average) of from 5000 to 20 000 g/mol has been obtained. This is preferably effected by separating off the melt by means of filtration. In another preferred embodiment, this can be effected by reprecipitation of the melt condensate in a solvent, e.g. in chloroform using acetone/n-heptane.

In a further variant of the invention, the catalyst can also remain in the reaction mixture during the solid phase condensation, as a result of which a higher molar mass is obtained in the same time. It is then, according to the invention, removed from the end product by melting the poly-L-lactic acid obtained and separating the melt from the supported catalyst by means of filtration. Solid poly-L-lactic acid particles having a diameter of preferably 100-250 μm can be obtained after the melt phase condensation according to the invention. The melting point is preferably 160° C., the crystallinity is preferably 50-60% and the molar mass M_{w} is preferably 20 000 g/mol.

As described above, a crystallization process, preferably at from 60 to 120° C., particularly preferably at about 110° C., can optionally be carried out before the solid phase condensation in one variant of the invention. Such crystallization processes are known to those skilled in the art. For example, the product of the melt phase condensation can be treated at the crystallization temperature in a gas phase. The time is not subject to any limits, but is preferably from 30 minutes to 1 hour. It has been found that a high crystallinity of the poly-L-lactic acid of from 35 to 50% or even 50-60% is achieved when using the supported and calcined zirconium sulfate which is preferably used according to the invention even without a crystallization step after the melt condensation. When the crystallization process is carried out, a crystallinity of the poly-L-lactic acid of 70-75% can be achieved.

If solid poly-L-lactic acid particles having the properties as described above are obtained in the melt phase condensation, the subsequent crystallization process is not necessary. These particles can be treated further by directly subsequent solid phase condensation.

The solid phase after-condensation following the melt phase condensation according to the invention is carried out at temperatures in the range from the glass transition temperature and the melting point (i.e. at about 120-160° C.) for at least 10 hours until a high molecular weight poly-L-lactic acid having a desired molar mass is formed. Depending on the molar mass desired, the solid phase condensation is carried out for from 20 hours to 3 days. In general, it is carried out under reduced pressure, preferably at about 0.05-8 mbar, in particular at 0.1-8 mbar, or under a stream of nitrogen.

In one variant of the invention, the oligomers obtained from the melt phase condensation and optionally subsequent crystallization are heated isothermally or stepwise. The setting of a stepwise temperature regime can be carried out by, for example, increasing the temperature from 120° C. to 130° C., then to 140° C., then to 150° C. and then to 160° C. and maintaining it for, for example, at least 5 hours in each stage. In the isothermal mode of operation, a particularly great molar mass increase up to 80 000 g/mol is obtained at relatively high temperatures such as 120-140° C. for at least 2 days, preferably 50-100 hours, particularly preferably 60-70 hours. This contradicts the previously known literature results. In the literature, the optimal time window is in the range from 20 to 40 hours under similar starting conditions (molar mass, crystallinity), and very long reaction times were always avoided. However, it has been found according to the invention that barely any molar mass increase was observed at reaction times of 20 hours.

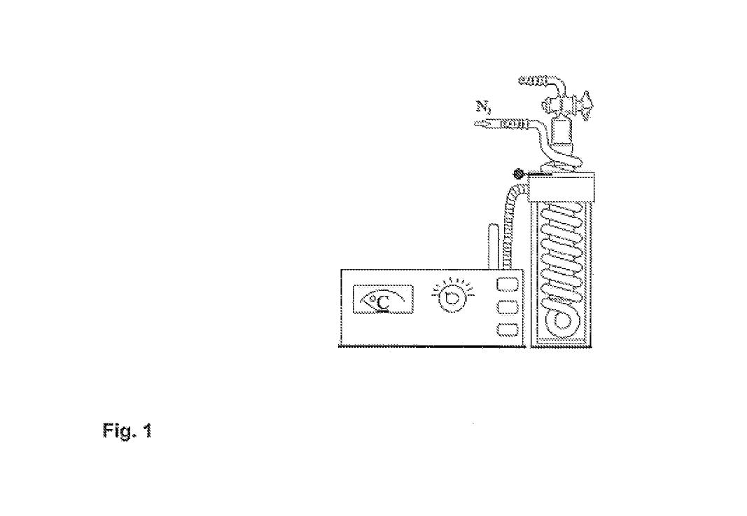

A tubular fixed-bed reactor which is preferably suitable for the solid phase condensation is shown in FIG. 1. If the condensation is carried out under reduced pressure, the thin film technique is used instead of a fixed bed.

As acidic and supported solid-state catalyst, preference is given according to the invention to using a calcined and supported zirconium sulfate (Zr(SO₄)₂). Zirconium sulfate is referred to as a green catalyst since it has a low toxicity. In addition, zirconium sulfate is not soluble in the melt phase condensation. It has been found that calcined and supported zirconium sulfate is a particularly active and selective catalyst.

According to the invention, mesoporous supports having high specific surface areas are used as support materials. Suitable support materials of this type are, for example, SiO₂, TiO₂, Al₂O₃, ZrO₂, Sb₂O₃, CaO, MgO and SnO, preferably SiO₂.

The supported catalyst is produced, for example, by diffusion impregnation or spray impregnation. The techniques are known to those skilled in the art and are described, for example, in the Handbook of Heterogeneous Catalysis 2nd Ed. Wiley-VCH, Weinheim 2008 by Gallei, E. F. et al. and U.S. Pat. No. 7,097,880 B2. In the production of the supported catalyst by spray impregnation, it is possible to use, for example, a precursor solution of the acidic solid-state catalyst as starting material and spray this onto the support. The amount of solution corresponds to the known pore volume of the support or is somewhat below this. In the case of diffusion impregnation, the support is impregnated with water, admixed with an aqueous precursor solution of the acidic solid-state catalyst, stirred and, after impregnation is complete, filtered off and washed with a little water.

If the supported zirconium sulfate catalyst which is preferred according to the invention is to be produced, the support is impregnated with zirconium sulfate tetrahydrate and subsequently calcined. In the case of the diffusion impregnation which is preferred according to the invention, the support, preferably silicon dioxide, is impregnated with water, then admixed with an aqueous solution of zirconium sulfate tetrahydrate and, after intensive stirring, preferably for about 24 hours, filtered off, washed with a little distilled water and dried. Spray impregnation is effected by spraying the zirconium sulfate tetrahydrate solution onto the dry support. Before use of the abovementioned impregnation techniques, the support, viz. the SiO₂, was baked for one hour at 500° C. in order to remove impurities from the pores. The degree of loading with zirconium sulfate tetrahydrate is 7-50% by weight, preferably about 30% by weight.

The supported zirconium sulfate tetrahydrate is then calcined at from 200 to 600° C., preferably at from 250 to 350° C. Calcination is carried out for from 1 to 4 hours, preferably for from about 1 to 3 hours. A supported zirconium sulfate catalyst which has been calcined at only from 250 to 350° C. has surprisingly been found to be particularly suitable for the process of the invention. Silicon dioxide is particularly preferably used as support. The optimal calcination temperature of about 300° C. cannot be derived from literature data since calcination is carried out there at far higher temperatures of about 600° C. for use in esterifications. In the case of the condensation of lactic acid, calcination at 600-800° C. displayed no influence on the activity.

The supported zirconium sulfate catalyst is preferably used in a concentration of 0.2-0.4% by weight, particularly preferably 0.3% by weight (defined in g of anhydrous zirconium sulfate per g of lactic acid based on the 90% strength by weight aqueous solution), in the melt phase condensation.

The process of the invention gives a catalyst-free poly-L-lactic acid which has a high molecular weight (weight average) of from >50 000 to 100 000 g/mol, preferably from 70 000 to 100 000 g/mol, in particular from 80 000 to 100 000 g/mol, and contains essentially no degradation products and displays a high crystallinity of from about 60% to >80%, preferably about 70-75%. The proportion of L-lactic acid units in the end product is preferably 98-99.5 mol %.

The catalyst according to the invention selectively catalyzes the esterification during the melt phase condensation, leads to a very low content of D-lactic acid and therefore to a semicrystalline material after the melt phase condensation. After a reaction time of 5 hours in the melt (number average about 5000 g/mol), no D-isomer could be found by means of chiral HPLC. Even after a reaction time of 20 hours, the proportion of D-isomer is only 0.5 mol %. After the melt phase condensation, the crystallinity could be increased further even in the variant according to the invention in which the catalyst had already been removed. The crystallinity is a measure of the high selectivity of a catalyst. The process of the invention gives a crystallinity in the product which can otherwise be achieved only by homogeneous catalysis.

The high degree of crystallinity of about 75% obtained according to the invention shows that racemization has surprisingly taken place to only a small extent.

The process of the invention thus enables a high molecular weight poly-L-lactic acid characterized by high purity, freedom from catalyst and high crystallinity to be prepared by using a very active and selective catalyst.

FIG. 1 schematically shows an apparatus for the solid phase after-condensation (BÜCHI GKR-50 with tubular fixed-bed reactor).

The invention is illustrated below with the aid of a working example.

### WORKING EXAMPLE 1

### a) Production of a Calcined Zirconium Sulfate Catalyst Coupled to Silicon Dioxide by Diffusion Impregnation

Zirconium sulfate was coupled to silicon dioxide as described by Juan, J. C. et al., Applied Catalysis A: General 2007, 332, 209-215.

Zirconium sulfate tetrahydrate is dissolved in distilled water by means of an ultrasonic bath Sonorex RK 52 H, frequency: 35 kHz for 3 minutes. Silicon dioxide having a pore volume of 2.65 ml/g is dispersed in distilled water and subsequently mixed with the aqueous zirconium sulfate solution and stirred constantly overnight (24 hours). A vacuum filtration is carried out after impregnation.

The filter cake is subsequently washed with small amounts of distilled water and dried in air. The amounts used in order to achieve different loadings can be taken from the following table.

Loading % by weight

| | 7 | 15 | 30 | 50 |
|---|---|---|---|---|
| Zirconium sulfate | 0.280 | 0.450 | 1.12 | 1.000 |
| tetrahydrate (g) | | | | |
| SiO₂ (g) | 2.233 | 2.233 | 2.233 | 0.900 |
| Distilled water for | 1.1 | 1.0 | 2.4 | 1.2 |
| dissolution of the | | | | |
| hydrate (g) | | | | |
| Distilled water for | 7.0 | 7.0 | 8.0 | 3.6 |
| dispersing the SiO₂ (g) | | | | |

The supported zirconium sulfate tetrahydrate having a loading of 30% by weight is subsequently calcined at 300° C. for 1 hour.

### b) Melt Phase Condensation

45 g of a 90% strength by weight aqueous solution of commercially available L-lactic acid are placed in a 250 ml vessel connected to a rotary evaporator. The temperature is set by means of an external oil bath. The reactor is also connected to a pump and a digital pressure control instrument. Between reactor and the pressure control instrument, a liquid nitrogen trap is integrated into the pressure line. The dewatering of the L-lactic acid is carried out at 80° C. under a pressure of 50 mbar for 30 minutes. After dewatering, a catalyst produced as per a) and calcined at 300° C. is added. The catalyst concentration is 0.3% by weight defined as g of anhydrous zirconium sulfate per g of lactic acid based on the 90% strength by weight aqueous solution. The reactor is subsequently rotated in the oil bath at 180° C. at a speed of rotation of 100 rpm. The pressure is reduced stepwise to 0.5 mbar over a period of 25 minutes and then kept constant for 5 hours at 0.5 mbar and a temperature of 180° C. The melt formed is then separated off from the catalyst by filtration. The polylactic acid formed was, after cooling in air, semicrystalline with a crystallinity of about 35%, and after dissolution in chloroform, reprecipitation in acetone/heptane (1:2% by volume) and drying at 8 mbar, 30° C. for 24 hours, was semicrystalline with a crystallinity of 54%. The molar mass (number average) is about 5000 g/mol after 5 hours. The conversion is 97.6%. When 0.7% by weight of zirconium sulfate was used, a number average of above 10 000 g/mol could be achieved after only 12 hours. In reactors having better mixing, a higher molar mass of at least 20 000 g/mol could be achieved under the same abovementioned conditions (stirred vessel, disk reactor).

### c) Solid Phase Condensation

The melt condensate is dissolved in chloroform (1:5% by weight) and added dropwise to a solution composed of acetone/heptane (1:2% by volume). After vacuum filtration, the solid was dried at 30° C. and 8 mbar for 24 hours. The fine powder was sieved (<250 m) and used directly for the crystallization and solid phase condensation. The crystallization took place at from 70 to 120° C. and 8 mbar for from 30 minutes to 1 hour.

The solid phase condensation was carried out in two different apparatuses, but no difference in the molar mass was observed. Apparatus 1: BÜCHI GKR-50 with bulb tube (horizontal) and vacuum connection (0.1 mbar).

Apparatus 2: The heatable tube of the BÜCHI GKR-50 is positioned vertically, and a glass tube with porous glass frit 2 on which about 5 g of sample were present was located in this (fixed bed). A very slow, dry, gaseous stream of nitrogen is passed through the tube from below. For the nitrogen to reach the desired temperature, it is passed through a glass coil around the large main tube. Additional drying of the nitrogen produced no difference in respect of the molar mass.

The temperature program was run from 120 to 160° C. stepwise in 5 or 10 hour intervals for at least 20 hours. This resulted in molar masses above 50 000 g/mol. The isothermal mode of operation with a long reaction time also gave high number averages of above 50 000 g/mol. The reaction should preferably be carried out at high temperatures such as 140° C. for at least 2 days, preferably for from 50 to 100 hours.

In a second variant according to the invention, the reaction was carried out under the above conditions and the catalyst was not removed after the melt phase condensation but instead only from the end product by melting the resulting poly-L-lactic acid and filtering the melt. The molar mass achieved was, as expected, higher here.

1. A process for preparing poly-L-lactic acid by direct polycondensation of L-lactic acid by means of melt-phase condensation and subsequent solid phase condensation, wherein L-lactic acid is subjected in the presence of an acidic and supported solid-state catalyst to the melt phase condensation and the catalyst is removed from the melt before the subsequent solid phase condensation or from the end product after the solid phase condensation.

2. The process as claimed in claim 1, wherein calcined zirconium sulfate (Zr(SO₄)₂) which is coupled to a support is used as acidic solid-state catalyst.

3. The process as claimed in claim 1, wherein the support is a mesoporous material, preferably selected from among SiO₂, TiO₂, Al₂O₃, ZrO₂, Sb₂O₃, CaO, MgO and SnO.

4. The process as claimed in claim 1, wherein the acidic and supported solid-state catalyst has been produced by impregnation of a support with zirconium sulfate tetrahydrate and subsequent calcination of the supported zirconium sulfate tetrahydrate at from 200 to 600° C., preferably from 250 to 350° C.

5. The process as claimed in claim 1, wherein calcined zirconium sulfate which is coupled to SiO₂ as support is used as acidic and supported solid-state catalyst.

6. The process as claimed in claim 1, wherein the melt phase condensation is carried out at from 150 to 200° C. with removal of the water liberated, preferably under reduced pressure.

7. The process as claimed in claim 1, wherein the catalyst is removed from the melt before the subsequent solid phase condensation by separating off the melt by means of filtration or the melt condensates being reprecipitated in a solvent.

8. The process as claimed in claim 1, wherein a crystallization process is carried out at from 60 to 120° C., preferably at from 70 to 120° C., particularly preferably at about 110° C., before the solid phase condensation.

9. The process as claimed in claim 1, wherein the solid phase condensation is carried out in the range from the glass transition temperature to the melting point for at least 20 hours.

10. The process as claimed in claim 1, wherein the catalyst is removed from the end product by the poly-L-lactic acid obtained being melted and the melt being separated off by means of filtration.

11. The process as claimed in claim 1, wherein the poly-L-lactic acid obtained has a crystallinity of from 60 to about 80%, a molar mass (weight average) of from 70 000 to 100 000 g/mol and a proportion of L-lactic acid units of more than 98 mol %.

12. A method of preparing high molecular weight poly-L-lactic acid, the method comprising:
using an acidic and supported solid-state catalyst to prepare a high molecular weight poly-L-lactic acid, by direct polycondensation of L-lactic acid by melt phase condensation and subsequent solid phase condensation.
